(19) United States
(12) Patent Application Publication
(10) Pub. No.: US 2014/0115327 A1
(43) Pub. Date: Apr. 24, 2014

(54) TRUST SERVICES DATA ENCRYPTION FOR MULTIPLE PARTIES

(71) Applicant: MICROSOFT CORPORATION, Redmond, WA (US)

(72) Inventors: Irina Gorbach, Bellevue, WA (US); Venkatesh Krishnan, Sammamish, WA (US); Rafayel Bezirganyan, Redmond, WA (US); Andrey Shur, Redmond, WA (US); Dmitry Denisov, Bellevue, WA (US); Lars Kuhtz, Seattle, WA (US)

(73) Assignee: Microsoft Corporation, Redmond, WA (US)

(21) Appl. No.: 13/657,246

(22) Filed: Oct. 22, 2012

(51) Int. Cl. H04L 29/06

(52) U.S. Cl. 713/165

(57) ABSTRACT

In one scenario, a computer system accesses a first principal's public key to generate a group private key that is encrypted using the first principal's public key. The generated group private key provides access to data keys that are used to encrypt data resources. The computer system accesses a second principal's public key to encrypt the generated group private key using the second principal's public key and encrypts at least one of the data keys using a group public key, where the data key allows access to encrypted data resources. The first principal then decrypts the group private key using the first principal's private key, decrypts the data key using the decrypted group private key and accesses the data resource using the decrypted data key. The second principal also performs these functions with their private key to access the data resource.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

In many cases, software applications are designed to interact with other software applications or other computer systems. For example, web browsers allow users to access information such as web pages, email, videos, music and other types of data. In some cases, enterprises or other organizations may provide data on these web servers that is intended only for certain users (e.g. employees). In such cases, the employees typically log in and are authenticated before being given access to the data. In other scenarios, enterprises or other organizations may provide some or all of their data via a third party data host such as a cloud hosting company. Such cloud hosting companies may provide the organization's data and/or applications to a wide variety of authenticated and unauthenticated users.

### BRIEF SUMMARY

Embodiments described herein are directed to generating a group key that allows multiple principals to access a specified data resource and to publishing encrypted data that is accessible by multiple different principals. In one embodiment, a computer system accesses a first principal's public key to generate a group private key that is encrypted using the first principal's public key. The generated group private key provides access to data keys that are used to encrypt data resources. The computer system accesses a second principal's public key to encrypt the generated group private key using the second principal's public key and encrypts at least one of the data keys using a group public key, where the data key allows access to encrypted data resources. The first principal then decrypts the group private key using the first principal's private key, decrypts the data key using the decrypted group private key and accesses the data resource using the decrypted data key. The second principal also decrypts the group private key using the second principal's private key, decrypts the data key using the decrypted group private key and accesses the data resource using the decrypted data key. In this manner, multiple users access encrypted data using the same group keys.

In another embodiment, a computer system performs a method for publishing encrypted data that is accessible by multiple different principals. A first principal publishes a portion of data that was encrypted using a data key of the first principal. A second principal accesses a group private key that was encrypted using both the first principal's public key and the second principal's public key. The second principal decrypts the group private key using the second principal's private key and decrypts the first principal's data key using the decrypted group private key. The second principal then uses the first principal's decrypted data key to access the encrypted portion of data published by the first principal.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a computer architecture in which embodiments described herein may operate including generating a group key that allows multiple principals to access a specified data resource.

FIG. 2 illustrates a flowchart of an example method for generating a group key that allows multiple principals to access a specified data resource.

FIG. 3 illustrates a flowchart of an example method for publishing encrypted data that is accessible by multiple different principals.

FIGS. 4-10C illustrate embodiments in which encryption keys are generated and used to encrypt data.

### DETAILED DESCRIPTION

Embodiments described herein are directed to generating a group key that allows multiple principals to access a specified data resource and to publishing encrypted data that is accessible by multiple different principals. In one embodiment, a computer system accesses a first principal's public key to generate a group private key that is encrypted using the first principal's public key. The generated group private key provides access to data keys that are used to encrypt data resources. The computer system accesses a second principal's public key to encrypt the generated group private key using the second principal's public key and encrypts at least one of the data keys using a group public key, where the data key allows access to encrypted data resources. The first principal then decrypts the group private key using the first principal's private key, decrypts the data key using the decrypted group private key and accesses the data resource using the decrypted data key. The second principal also decrypts the group private key using the second principal's private key, decrypts the data key using the decrypted group private key and accesses the data resource using the decrypted data key. In this manner, multiple users access encrypted data using the same group keys.

In another embodiment, a computer system performs a method for publishing encrypted data that is accessible by multiple different principals. A first principal publishes a portion of data that was encrypted using a data key of the first principal. A second principal accesses a group private key that was encrypted using both the first principal's public key and the second principal's public key. The second principal decrypts the group private key using the second principal's private key and decrypts the first principal's data key using the decrypted group private key. The second principal then uses the first principal's decrypted data key to access the encrypted portion of data published by the first principal.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions in the form of data are computer storage media. Computer-readable media that carry computer-executable instructions are transmission media. Thus, by way of example, and not limitation, embodiments described herein can comprise at least two distinctly different kinds of computer-readable media: computer storage media and transmission media.

Computer storage media includes RAM, ROM, EEPROM, CD-ROM, solid state drives (SSDs) that are based on RAM, Flash memory, phase-change memory (PCM), or other types of memory, or other optical disk storage, magnetic disk storage or other magnetic storage devices, or any other medium which can be used to store desired program code means in the form of computer-executable instructions, data or data structures and which can be accessed by a general purpose or special purpose computer.

A “network” is defined as one or more data links and/or data switches that enable the transport of electronic data between computer systems and/or modules and/or other electronic devices. When information is transferred or provided over a network (either hardwired, wireless, or a combination of hardwired or wireless) to a computer, the computer properly views the connection as a transmission medium. Transmission media can include a network which can be used to carry data or desired program code means in the form of computer-executable instructions or in the form of data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”), and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that various embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments described herein may also be practiced in distributed system environments where local and remote computer systems that are linked (either by hardwired data links, wireless data links, or by a combination of hardwired and wireless data links) through a network, each perform tasks (e.g. cloud computing, cloud services and the like). In a distributed system environment, program modules may be located in both local and remote memory storage devices.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

Additionally or alternatively, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), and other types of programmable hardware.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

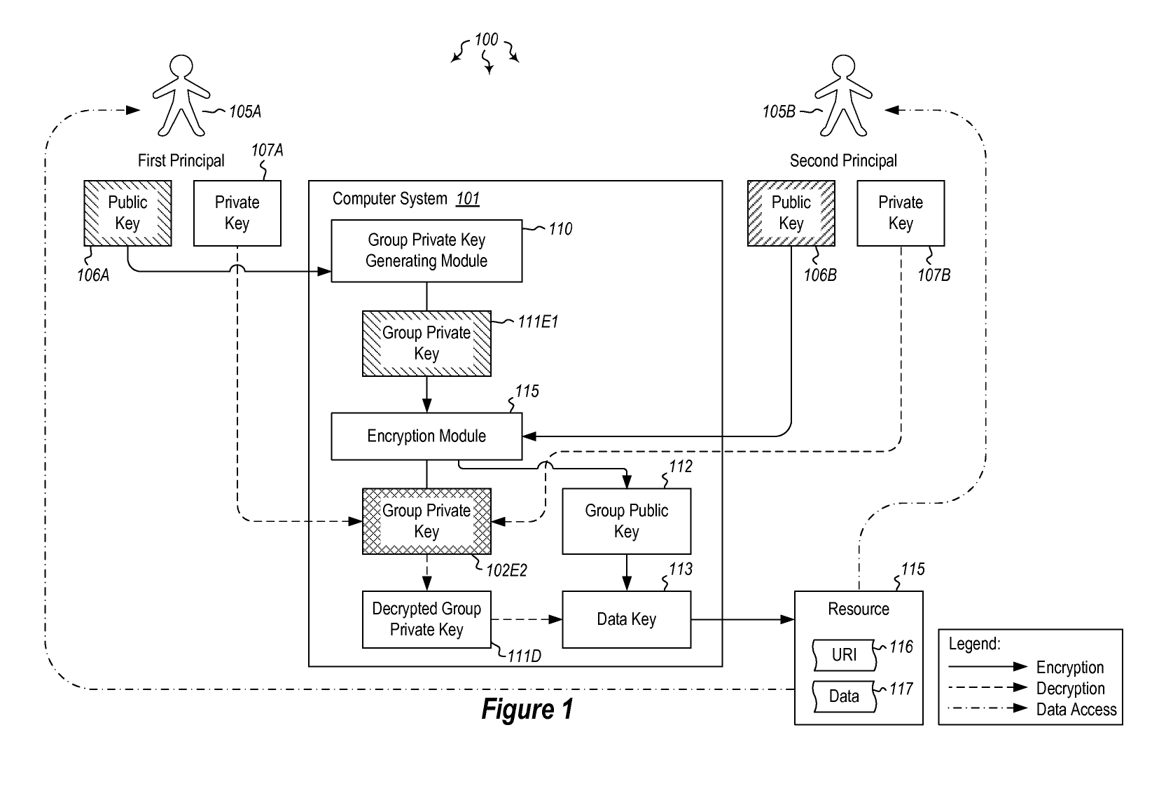

FIG. 1 illustrates a computer architecture 100 in which at least one embodiment may be employed. Computer architecture 100 includes computer system 101. Computer system 101 may be any type of local or distributed computer system, including a cloud computing system. The computer system includes various modules for performing a variety of different functions. For instance, the group private key generating module 110 may generate a group private key 111E1. The group private key may be used to access resources 115 including data 117. The group private key may be encrypted by one or more different principals' public keys. For instance, the group private key 111E1 may be encrypted using first principal 105A's public key 106A. Thus, group private key 111E1 is shaded to show that it has been encrypted using public key 106A. The group private key may also be encrypted with other user's public keys (using encryption module 115), including public key 106B of second principal 105B. Accordingly, group private key 111E2 may be encrypted with both public key 106A and 106B.

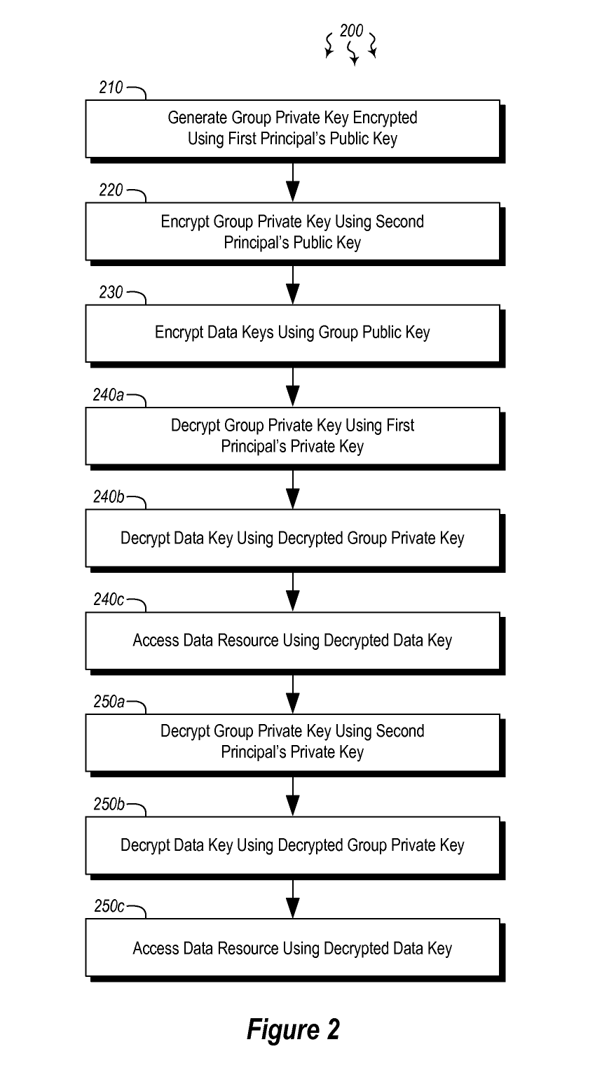

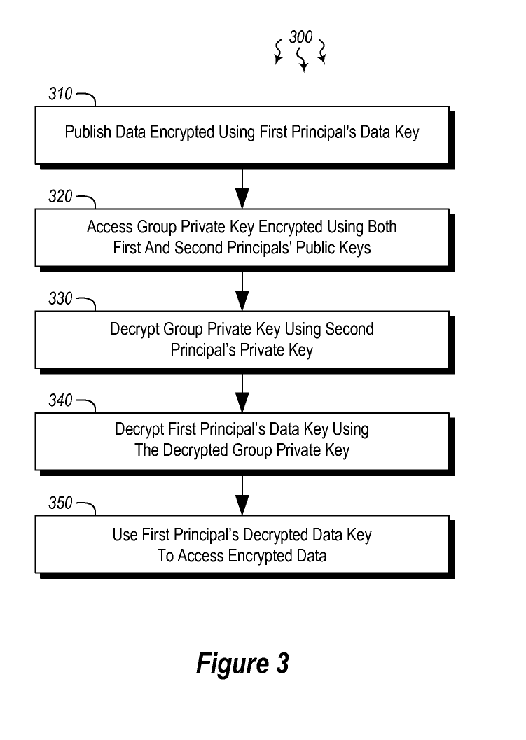

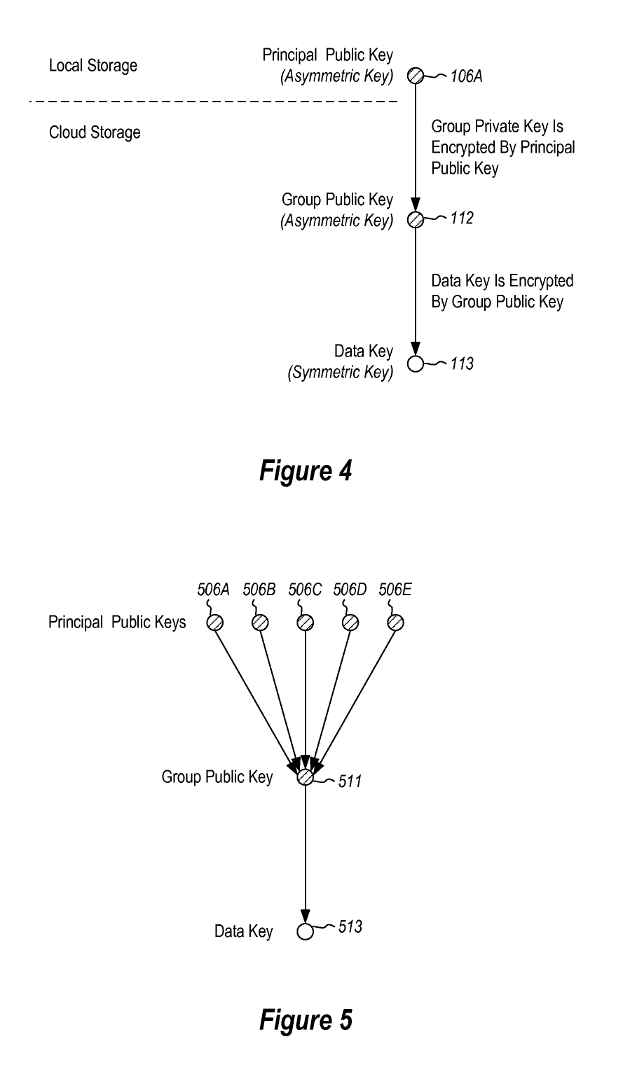

The encrypted group private key 111E2 may then be decrypted by either the first principal 105A or the second principal 105B using their private keys (107A and 107B, respectively). The decrypted group private key 111D may then be used to access a data key 113. The data key is the key used to encrypt the data 117 of resource 115. The data key itself is encrypted using a group public key 112, which can be decrypted using the decrypted group private key 111D. Once the data key 113 is decrypted, the data key can be used by the principal to access the encrypted data. In this manner, a single group private key may be used which allows multiple users to access a piece of data. These concepts will be explained further below with regard to FIGS. 4-9, and with regard to the methods 200 and 300 of FIGS. 2 and 3.

Embodiments described herein refer to data encryption and using various forms of encryption to protect sensitive data on distributed or cloud computing systems. To protect sensitive information, the data (either entirely or in parts) is encrypted before it is stored in the cloud. The data is often divided into smaller logical units or resources (e.g. rows in a table or files in a folder) where each resource is encrypted with its own key. In some cases, policy may dictate that keys with which resources are encrypted are periodically “rolled” or updated, depending on the sensitivity of the data. Systems that allow such protection of data may produce a substantial amount of key material which may be difficult to maintain. Moreover, in some cases, policy may dictate that encryption keys are to be shared between multiple parties. Such an implementation can potentially multiply the amount of key material maintained by such system.

Some embodiments described herein are directed to storing encryption keys in the cloud in an encrypted form and providing proper infrastructure for roaming. Roaming in this context refers to the ability to authorize principals to decrypt the keys, as well as ability to revoke such authorization. Because encryption keys are stored in the cloud, no peer-to-peer communication is used when performing the roaming.

FIG. 4 shows three different kinds of keys: principal keys (e.g. 106A and 107A), group keys (e.g. 111E1, 112) and data keys (e.g. 113). At least in some embodiments, principal keys and group keys are asymmetric, while data keys are symmetric. Principals' private keys are stored locally, and are only available to the principal. Group private and public keys, as well as data keys, are stored in the cloud. Group private keys are encrypted with principals' public keys and, hence, can only be decrypted by the principal private key. Data keys are encrypted with group public key and, hence can only be decrypted by the group private key. Thus, in order for a principal to obtain a data key, the principal first decrypts the group private key using its private key, and then decrypts the data key using the group private key. In other words, access to data keys is done through group keys.

In FIG. 5, multiple principals are given access to a data key. Thus, each of the five principals' public keys (506A-506E) provide access to the data key 513 through the group private key 511. The group private key 511 is encrypted by each principal's public key (506A-506E), and the data key is encrypted by the group public key. The principal uses their own private key (e.g. 107A) to decrypt the group private key, and uses the decrypted group private key (e.g. 111D) to decrypt the data key 513 that was encrypted using the group public key. The decrypted data key can then be used to access the encrypted data.

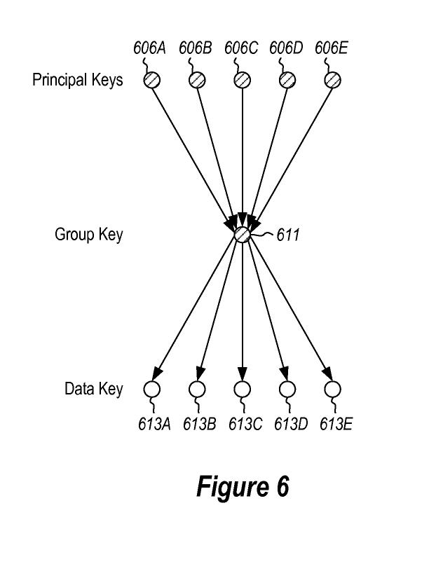

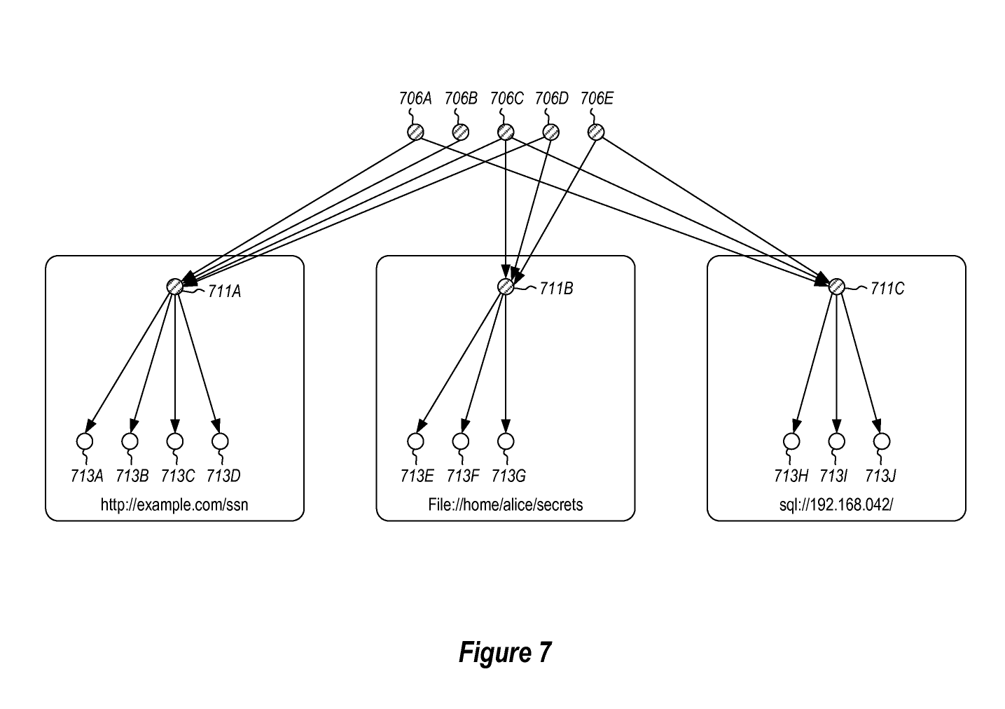

In one embodiment, each principal who wishes to publish data uses their own data key to encrypt the data. The other principals are able to decrypt this data key using the group private key, and use the data key to decrypt the data (as shown in FIG. 6). Thus, in FIG. 6, the principals use their private keys (607A-607E) to decrypt the private group key, and use the decrypted private group key 611 to decrypt the other principals' data keys (613A-613E) that were encrypted using a group public key. As such, principals use individual data keys to encrypt the data, but share group keys to decrypt the data. In FIG. 7, the process of FIG. 6 is repeated for the resources within the system. Thus, data keys are partitioned by uniform resource identifiers (URIs). The URI “http://example.com/ssn” has its own data keys 713A-713D, the URI “file://home/alice/secrets” has its own data keys 713E-713G, and URI “sq1://192.168.0.42/” has data keys 713H-713J. Each URI has its own group private key (711A, 711B or 711C, respectively) associated with it, which provides the principals access to the data keys in the manner described above.

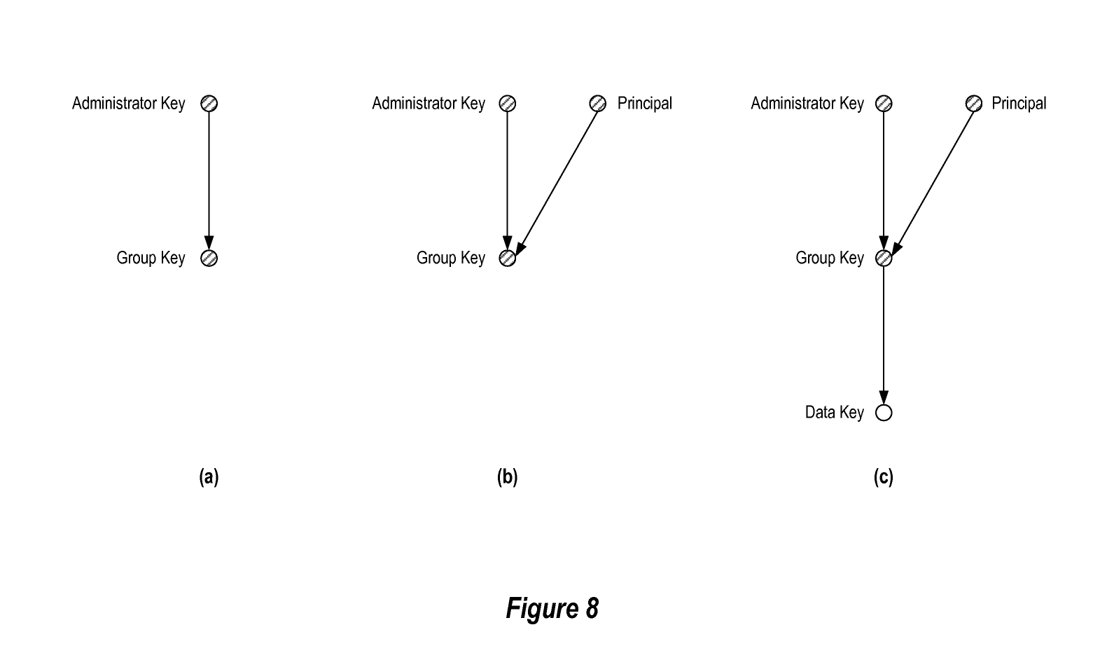

FIG. 8 describes how principals are authorized to access data keys. In some embodiments, there is one principal among all the principals who is appointed to be an administrator. Before any data key is published and used, an administrator first creates a group key (in step (a)). At this point, only the administrator has access to the group private key. To grant authorization to a URI, the administrator encrypts group private key with principal's public key (in step (b)). Once authorized, the principal can use existing keys for decryption or create their own data key for encryption of the data they publish (in step (c).

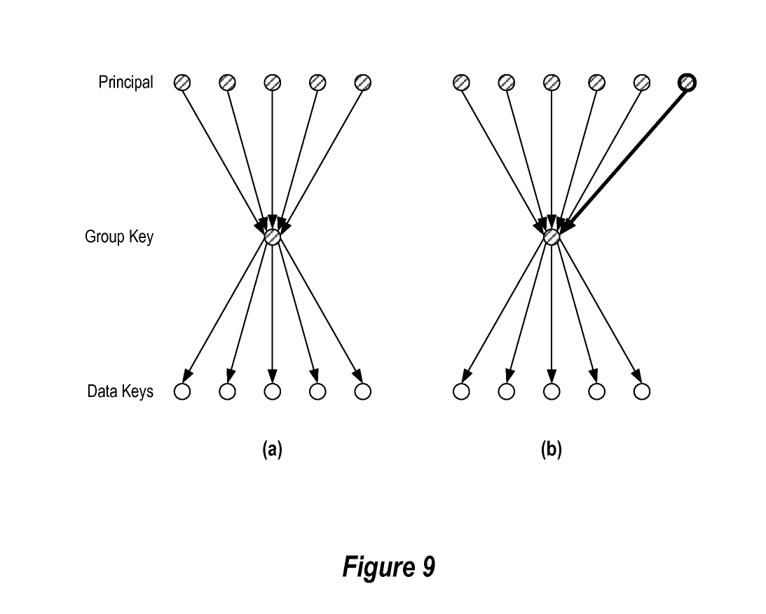

In FIG. 9, authorization is given to an existing group of principals. The existing group has some number of principals and each principal has their own data key (as shown in (a)). During authorization, the group private key is encrypted with each principal's public key, which grants the principal access to all of the data keys in the group (as shown in (b)). It should be noted that, in the embodiments shown in FIGS. 8 and 9, the administrator is always authorized to all URIs, since it is the administrator that creates group keys.

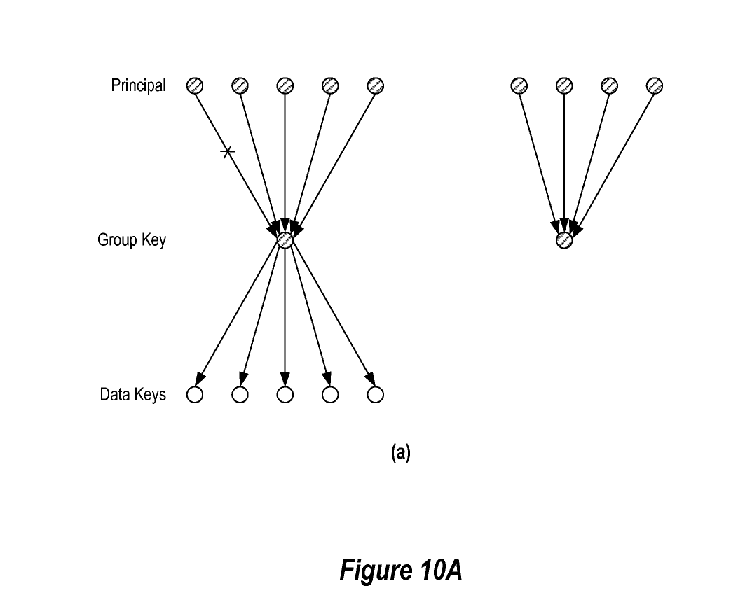

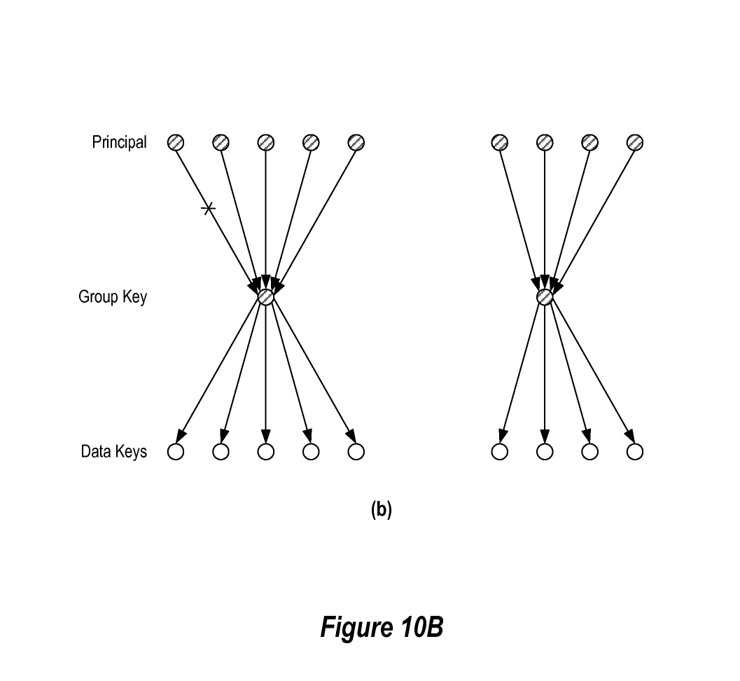

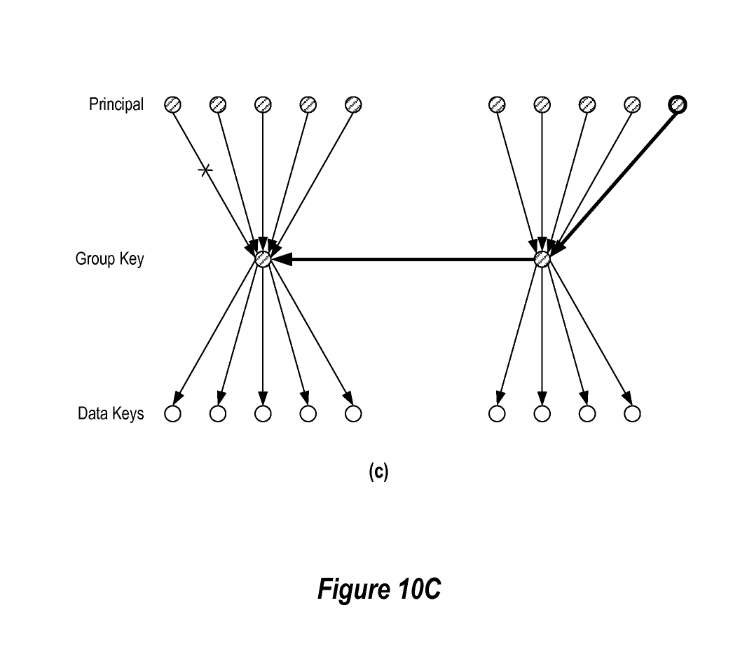

FIG. 10 describes how principals' authorization to access data keys is revoked. When the administrator revokes authorization from a principal, the admin creates a new group key and encrypts it to all principals that are authorized for that URI except for the principal whose authorization is being revoked (as shown in (a) of FIG. 10A). To allow accessing existing data keys, the previous group key is encrypted to the newly created group key. The newly created group key is marked as active and the all principals who wish to continue to publish data, have to create new data keys and publish them under the new group (as shown in (b) of FIG. 10B). Because the unauthorized principal does not have access to the new group key, data keys that were published after the revocation, will not be accessible to that principal (as shown in (c) of FIG. 10C). Older or previously used data keys can only be used to decrypt the data that was previously encrypted by them. These concepts will be explained further below with regard to methods 200 and 300 of FIGS. 2 and 3, respectively.

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

FIG. 2 illustrates a flowchart of a method 200 for generating a group key that allows multiple principals to access a specified data resource. The method 200 will now be described with frequent reference to the components and data of environment 100 of FIG. 1.

Method 200 includes an act of accessing a first principal's public key to generate a group private key that is encrypted using the first principal's public key, the generated group private key providing access to one or more data keys (act 210). For example, group private key generating module 110 of computer system 101 may access public key 106A belonging to first principal 105A. The public key 106A may be used by encryption module 115 to encrypt the group private key 11E1. Both the group private key and the group public key 112 are stored on a distributed or cloud computing system. The group private key is stored in encrypted form on the cloud and, as such, is only accessible to those with a key that can decrypt the group private key (i.e. principal private keys 107A and 107B).

Resources accessible via the group private key are also encrypted using a data key 113. The data key itself is encrypted using the group public key and, as such, is only available to those users that can access the group private key. The resource 115 is encrypted and stored on the cloud and may include data 117 or other resources. The resources may be identified with uniform resource identifiers (URIs) 116. Each principal that publishes data (e.g. data 117) uses their own private data key to encrypt the data. The data encrypted by the principal's private key is accessible using the group private key and data key. Accordingly, data published by one principal is accessible by all other principals that have access to the group private key. As mentioned above, the principal and group public and private keys are asymmetric keys, and the data key is a symmetric key.

Method 200 includes an act of accessing a second principal's public key to encrypt the generated group private key using the second principal's public key (act 220). Thus, as mentioned above, second principal 105B's public key 106B may be used to encrypt the group private key 111E2, in addition to its encryption using first principal 105A's public key 106A. Method 200 also includes an act of encrypting at least one of the one or more data keys using a group public key, the data key allowing access to a data resource (act 230). Thus, resource 115 may be encrypted using data key 113, which itself is encrypted using group public key 112. The resource may include multiple different portions of data 117. Each portion of data may be encrypted by a different data key and may be identified by a different URI.

Method 200 further includes an act of the first principal decrypting the group private key using the first principal's private key (act 240a), decrypting the data key using the decrypted group private key (act 240b), and accessing the data resource using the decrypted data key (act 240c). The second principal can also decrypt the group private key using the second principal's private key (act 250a), decrypt the data key using the decrypted group private key (250b) and access the data resource using the decrypted data key (act 250c). Thus, multiple different principals can access data on the cloud that has been encrypted using a data key. The data key is only decryptable by users that have access to the decrypted group private key.

In some embodiments, the first and second principals 105A and 105B are authorized to access a second, different data resource. In such an embodiment, the first and second principals each encrypt the group private key with their respective public keys in order to access the second data resource. The first principal's authorization to access the second data resource may be revoked by an administrator when desired. The administrator may revoke the principal's authorization by generating a new group private key that is encrypted by another principal's (e.g. the second principal's public key) and then by all other's public keys that are authorized to have access to the data resource protected by the group key. Data that was encrypted using the old keys is still accessible using the old keys. As such, when authorization is revoked, the data portions should be re-encrypted using the newly generated keys.

FIG. 3 illustrates a flowchart of a method 300 for publishing encrypted data that is accessible by multiple different principals. The method 300 will now be described with frequent reference to the components and data of environment 100 of FIG. 1.

Method 300 includes an act of determining that a portion of data was published by a first principal that was encrypted using the first principal's data key (act 310). For example, computer system 101 may determine that data portion 117 was published by first principal 105A, and as such, was encrypted using the first principal's data key. The second principal 105B may access a group private key 111E2 that was encrypted using both the first principal's public key and the second principal's public key (act 320). In some cases, the first and second principals may generate their own public, private and data keys (as opposed to having the keys generated by the cloud). Each data key may be used to encrypt a resource identified by a URI (e.g. resource 115). Each portion of data within the data resource may also be encrypted with its own data key (as shown in FIG. 7). In this manner, data encryption keys may be partitioned by URI.

Method 300 further includes an act of the second principal decrypting the group private key using the second principal's private key (act 330) and the second principal decrypting the first principal's data key using the decrypted group private key (act 340). Method 300 then includes an act of the second principal using the first principal's decrypted data key to access the encrypted portion of data published by the first principal (act 350). In this manner, multiple different principals can use their corresponding private keys to decrypt whatever has been encrypted using a single URI group key. Individual keys are thus used to encrypt data, while group keys allow decryption of that data.

Accordingly, methods, systems and computer program products are provided which generate a group key that allows multiple principals to access a specified data resource. Moreover, methods, systems and computer program products are provided which publish encrypted data that is accessible by multiple different principals.

The concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A computer system comprising the following:
one or more processors;
system memory;
one or more computer-readable storage media having stored thereon computer-executable instructions that, when executed by the one or more processors, causes the computing system to perform a method for generating a group key that allows multiple principals to access a specified data resource, the method comprising the following:
an act of accessing a first principal's public key to generate a group private key that is encrypted using the first principal's public key, the generated group private key providing access to one or more data keys;
an act of accessing a second principal's public key to encrypt the generated group private key using the second principal's public key;
an act of encrypting at least one of the one or more data keys using a group public key, the data key allowing access to a data resource;
an act of the first principal performing the following:
decrypting the group private key using the first principal's private key;
decrypting the data key using the decrypted group private key; and
accessing the data resource using the decrypted data key; and
an act of the second principal performing the following:
decrypting the group private key using the second principal's private key;
decrypting the data key using the decrypted group private key; and
accessing the data resource using the decrypted data key.

2. The computer system of claim 1, wherein the group private key and group public key are stored on a distributed computing system.

3. The computer system of claim 2, wherein the group private key is stored in encrypted form on the distributed computing system.

4. The computer system of claim 2, wherein the data resource is encrypted and stored on the distributed computing system.

5. The computer system of claim 4, wherein the encrypted data resource is identified by a uniform resource identifier (URI).

6. The computer system of claim 1, wherein each principal that publishes data uses their own private data key to encrypt the data.

7. The computer system of claim 6, wherein data encrypted by a principal's private key is accessible using the group private key and data key.

8. The computer system of claim 1, wherein the data resource includes a plurality of different data portions.

9. The computer system of claim 8, wherein each of the plurality of data portions of a specified resource is encrypted with its own data key.

10. The computer system of claim 1, wherein the first and second principals are authorized to access a second data resource, and wherein the first and second principals each encrypt the group private key with their respective public keys in order to access the second data resource.

11. The computer system of claim 10, wherein the first principal's authorization to access the second data resource is revoked by generating a new group private key that is encrypted by the second principal's public key.

12. The computer system of claim 11, wherein at least one new data key is generated to encrypt the data resource.

13. The computer system of claim 12, wherein the original data key is used to decrypt the data that was previously encrypted by it.

14. The computer system of claim 1, wherein principal and group public and private keys are asymmetric keys.

15. The computer system of claim 1, wherein the data key is a symmetric key.

16. A computer system comprising the following:
one or more processors;
system memory;
one or more computer-readable storage media having stored thereon computer-executable instructions that, when executed by the one or more processors, causes the computing system to perform a method for publishing encrypted data that is accessible by multiple different principals, the method comprising the following:
an act of determining that a portion of data was published by a first principal that was encrypted using the first principal's data key;
an act of a second principal accessing a group private key that was encrypted using both the first principal's public key and the second principal's public key;
an act of the second principal decrypting the group private key using the second principal's private key;
an act of the second principal decrypting the first principal's data key using the decrypted group private key; and
an act of the second principal using the first principal's decrypted data key to access the encrypted portion of data published by the first principal.

17. The computer system of claim 16, wherein the first and second principals generate their own public, private and data keys.

18. The computer system of claim 16, wherein each data key is used to encrypt a resource identified by a URI.

19. The computer system of claim 18, wherein one or more of the data encryption keys are partitioned by URI.

20. A computer system comprising the following:
one or more processors;
system memory;
one or more computer-readable storage media having stored thereon computer-executable instructions that, when executed by the one or more processors, causes the computing system to perform a method for generating a group key that allows multiple principals to access a specified data resource, the method comprising the following:
an act of accessing a first principal's public key to generate a group private key that is encrypted using the first principal's public key, the generated group private key providing access to one or more data keys;
an act of accessing a second principal's public key to encrypt the generated group private key using the second principal's public key;
an act of encrypting at least one of the one or more data keys using a group public key, the data key allowing access to a data resource;
an act of notifying the first principal that they are authorized to access the data resource using the encrypted data key;
an act of the first principal performing the following:
decrypting the group private key using the first principal's private key;
decrypting the data key using the decrypted group private key; and
accessing the data resource using the decrypted data key;
an act of notifying the second principal that they are authorized to access the data resource using the encrypted data key; and
an act of the second principal performing the following:
decrypting the group private key using the second principal's private key;
decrypting the data key using the decrypted group private key; and
accessing the data resource using the decrypted data key.
